(19) United States
(12) Patent Application Publication
(10) Pub. No.: US 2012/0074309 A1
(43) Pub. Date: Mar. 29, 2012

(54) INDUCTIVELY COUPLED PLASMA MASS SPECTROSCOPY APPARATUS AND MEASURED DATA PROCESSING METHOD IN THE INDUCTIVELY COUPLED PLASMA MASS SPECTROSCOPY APPARATUS

(75) Inventors: Kazushi HIRANO, Tokyo (JP); Tetsuya KANDA, Tokyo (JP)

(73) Assignee: AGILENT TECHNOLOGIES, INC., Loveland, CO (US)

(21) Appl. No.: 13/237,179

(22) Filed: Sep. 20, 2011

Related U.S. Application Data
(60) Provisional application No. 61/385,566, filed on Sep. 23, 2010.

(51) Int. Cl. H01J 49/26

(52) U.S. Cl. 250/282; 250/288

(57) ABSTRACT

The present invention performs measurement for determining a P/A coefficient and/or determination of the P/A coefficient after measurement of a standard density sample for density calibration in an ICP-MS. Specifically, after measuring signal intensity of each mass number in the standard density sample, the P/A coefficient is determined from the signal intensity for a mass number having the signal intensity within a P/A coefficient calibration range, while for a mass number having the signal intensity above the calibration range, a voltage applied to an ion lens of the ICP-MS is changed so that the signal intensity becomes within the calibration range, to thereby adjust an ion transmission ratio of the ion lens, and then the P/A coefficient is determined from the signal intensity determined within the calibration range.

### BACKGROUND OF THE INVENTION

1. Field of the Invention

The present invention relates to an inductively coupled plasma mass spectroscopy apparatus (ICP-MS), and more particularly, to a method of processing measured data determined by the inductively coupled plasma mass spectroscopy apparatus.

2. Description of the Related Art

The ICP-MS has a dynamic range of measured signals as wide as nine digits, and the signal measurement is usually performed by a plurality of methods in accordance with an intensity of the signal. Therefore, it is necessary to associate a plurality of types of measured values determined by the individual methods by calibration. Typically, there are adopted two methods including a pulse count method and an analog current method. The calibration in this case is performed by measuring in a calibration range that is an overlapping signal range in which the measured signals deter-lined in the two methods are both effective and by determining a ratio between measured signal levels of both methods (P/A coefficient). Usually, it is desirable to perform the calibration individually for each element to be measured because the ratio of signal levels is different depending on the element to be measured. Therefore, it is desirable to perform the calibration individually for every element to be measured.

Here, with reference to FIG. 1 illustrating a block diagram of a conventional ICP-MS that can measure a pulse count value and an analog current value simultaneously or selectively, an outline of an operation thereof is described. An automatic sampler 10 as an option or an operator contacts a sample suction tube connected to a sample lead-in part 15 with liquid of sample 5 to be measured in a sample bottle, and the sample 5 is led from the sample lead-in part 15 to an ionization part 20. Thus, elements included in the sample 5 are ionized by plasma generated in the ionization part 20. The ionized elements are sampled in an interface part 25 constituting a differential exhaust system including a sampling cone and a skimmer cone, and are led into a high vacuum chamber including an ion lens part 30, a mass segregation part 35, and a detector 42. Then, the ionized elements are converged by the ion lens part 30 and enter the mass segregation part 35 that is typically constructed of a quadrupole mass filter for transmitting only ions of a selected mass number.

The detector 42 is typically constructed of a secondary electron multiplier, and outputs an electric signal corresponding to the number of reaching ions of the mass number segregated by the mass segregation part 35 per unit time. The electric signal output from the secondary electron multiplier is sent to a pulse counter 44 and an analog current measuring part 46. Then, a pulse count value corresponding to a pulse frequency of the electric signal and an analog current value of the electric signal are measured by the pulse counter 44 and the analog current measuring part 46, respectively. The detector 42, the pulse counter 44, and the analog current measuring part 46 constitute an ion measuring part 40.

An ion lens voltage drive part 55 works so as to apply a voltage to an ion lens in the ion lens part 30. The ion lens includes an electric field lens unit having an action of changing trajectories of ions utilizing an electric field, and is constructed such that an ion transmission ratio changes in accordance with a change of the voltage applied to an electrode of the ion lens. Therefore, when a system control part 60 controls the ion lens voltage drive part 55 so as to change the voltage applied to the electrode of the ion lens, the ion transmission ratio of the ion lens can be increased or decreased. In normal measurement, the voltage applied to the ion lens is set to a predetermined voltage such that a transmission ratio of every element to be a target of analysis in the sample to be measured maximized as much as possible.

The system control part 60 controls operation of each block illustrated in FIG. 1.

An operation processing part 65 checks whether or not an intensity of the measured signal is larger than a predetermined value in the normal measurement for quantifying the density of an element in the sample to be measured. If the intensity is larger than the predetermined value, the analog current value from the analog current measuring part 46 is adopted as the effective measured value. If the intensity is smaller than the predetermined value, the pulse count value from the pulse counter 94 is adopted as the effective measured value. This is because that the pulse count value is apt to be saturated in a region having large signal intensity, while an S/N ratio of the analog current is apt to be deteriorated in the region having small signal intensity. Therefore, it is necessary to adopt a measured value having higher reliability in accordance with signal intensity. The operation processing part 65 performs a process of determining a ratio between the measured values (P/A coefficient) for converting the measured analog current value into the pulse count value for each mass number.

In general, in order to obtain an effective P/A coefficient of a certain mass number, it is necessary to calculate the P/A coefficient between the analog current value and the pulse count value determined in a P/A coefficient calibration range (hereinafter, referred to as calibration range) that is an overlapping signal intensity range in which both the analog current value and the pulse count value measured for the mass number are effective. In addition, the signal intensity with respect to the sample density is different depending on the element. Therefore, it is necessary in the conventional method to prepare samples for P/A coefficient calibration having different densities for each element so that a signal in the calibration range can be determined for each element, and to perform measurement for determining the P/A coefficient. Therefore, it is bothersome for a user of the ICP-MS to determine the P/A coefficient.

In this point, U.S. Pat. No. 5,463,219 discloses a structure for discriminating which one of four measurement regions, including a pulse only region, a calibration region, an analog signal only region, and a neither pulse nor analog region, the measurement region of the measured data is in the ICP-MS system including dual output electron multipliers that can measure both the pulse count signal and the analog signal of the sample to be measured simultaneously, at the same time when the signal intensity is measured. The system further has a structure in which a voltage to be applied to the ion lens is changed so that data measured in the analog signal only region or the neither pulse nor analog region when a normal voltage is applied can be measured in the calibration region. With this structure, the P/A coefficient can be determined from a pulse count signal and an analog signal measured in the calibration region for the sample to be measured. Therefore, the P/A coefficient can be determined without measurement using the sample for P/A coefficient calibration.

However, in the system disclosed in U.S. Pat. No. 5,963,219, a measured value of the element in the sample to be measured is used for determining the P/A coefficient, and the density of the element in the sample to be measured is uncertain. For this reason, if the sample to be measured contains a low density element such that only a measured value in the pulse only region can be determined even if the transmission ratio of the ion lens is maximized for each element, the measured value of the element cannot be in the calibration range by adjustment of the transmission ratio of the ion lens. Therefore, the P/A coefficient cannot be determined for such element.

Further, in the system disclosed in U.S. Pat. No. 5,463,219, the voltage to be applied to the ion lens is changed step by step so that the measured signal can be determined over a wide range for determining the measured value of each element securely in the calibration range for every desired element in the sample to be measured. This method needs a lot of time for measurement to determine the P/A coefficient because the measurement is performed at many voltage points.

In addition, the system disclosed in U.S. Pat. No. 5,463,219 needs special hardware such as a comparator for comparing the measured analog signal voltage with some predetermined voltages so as to discriminate which signal region the measured signal belongs to. Therefore, it is not easy to perform the method disclosed in U.S. Pat. No. 5,463,219 utilizing an existing ICP-MS.

Besides the above-mentioned problem in the conventional P/A coefficient determining method, there is another problem that the conventional P/A coefficient estimation method for estimating a P/A coefficient of a certain element to which the P/A coefficient is not given in the given ICP-MS has relatively large estimation error.

In the given ICP-MS that is about to measure a certain sample, a situation where the P/A coefficient of the mass number to be measured is not given yet may occur in the case where the sample to be measured happens to contain, because is an unknown sample, for example, an element of a mass number having a P/A coefficient that is not determined by the given ICP-MS, or an element whose signal intensity cannot measured in the calibration range because the density in the sample for P/A calibration is too low.

In this case, conventionally, it is regarded that the P/A coefficient of the element exists only in the mass number of the element, and an linear interpolation approach is adopted in which known P/A coefficients of two different mass numbers having a relationship that a mass number having an undetermined P/A coefficient exists between them are connected by a straight line and a value on the straight line of the mass number for which the P/A coefficient is to be determined is regarded as an estimated value of the P/A coefficient of the mass number.

FIG. 11 is a graph showing an example of estimation of the P/A coefficient by the conventional linear interpolation based on a dependence of the P/A coefficient on the mass number. The horizontal axis (x axis) represents the mass number, and the vertical axis (y axis) represents the P/A coefficient. Five points indicated by squares in the graph are obtained by plotting the P/A coefficients that are determined in advance in the given ICP-MS with respect to the mass numbers.

Each of the four straight lines illustrated by the dot lines in FIG. 11 connects two points having neighboring mass numbers among the five points. For instance, the straight line part L in FIG. 11 connects the P/A coefficients corresponding to the mass numbers of 69 amu and 238 amu, respectively. The P/A coefficient corresponding to the mass number of 137 of the element Ba between the two mass numbers is estimated as a y coordinate value when the x coordinate value is 137 in the linear equation representing the straight line L.

However, the P/A coefficient depends not just on the mass number, and hence an error of the estimated value is apt to increase relatively when the P/A coefficient is estimated by the linear interpolation on the basis of only the dependence on the mass number. Therefore, a P/A coefficient estimation method with higher accuracy is necessary.

### SUMMARY OF THE INVENTION

A first object of the present invention is to make it possible to determine a P/A coefficient for every desired element without preparing a sample for P/A coefficient calibration.

A second object of the present invention is to make it possible to determine a P/A coefficient without adding special hardware, namely by using existing ICP-MS hardware with no modification or with minimum modification to the same, in an ICP-MS that can measure a signal intensity in a plurality of measuring modes.

A third object of the present invention is to make it possible to determine a P/A coefficient quickly and securely for every desired element without preparing a sample for P/A coefficient calibration.

In order to achieve the first and second objects, the present invention determines the P/A coefficient by utilizing measurement for density calibration using a standard density sample. In analysis of the sample by the ICP-MS, the density of each element is quantified from a signal intensity determined for the element of each mass number in the sample. Therefore, density calibration using a standard density sample is usually performed so as to generate a working curve before measuring the sample. In the present invention, following this measurement of each sample for generating the working curve, measurement for determining the P/A coefficient and/or determination of the P/A coefficient is performed. Specifically, after finishing measurement of the standard density sample for density calibration, first, the P/A coefficient is determined for a mass number having the signal intensity within the calibration range. Then, as for a mass number having the signal intensity above the calibration range, the ion transmission ratio of the ion lens is decreased so that signal sensitivity of the ICP-MS is attenuated. Thus, the P/A coefficient is determined using measured data obtained when the signal intensity becomes within the calibration range.

The standard density sample can be prepared so as to include a density range in which the quantification is performed for each element to be measured. According to this method, as for an element of a mass number for which the P/A coefficient should be determined, the P/A coefficient can be determined at least one time in generating the working curve. Therefore, the first object can be achieved. Further, the method can be automatically performed by software incorporated in microprocessors constituting the system control part 60 and the operation processing part 65, respectively. Therefore, the second object can be achieved. According to the function of automatically performing the P/A coefficient determining process using a standard density sample, the user of the ICP-MS can perform the density calibration only by performing the operation for density calibration without being conscious of determining the P/A coefficient. In addition, the user can get automatically the P/A coefficient of the desired mass number substantially at the same time as achieving the density calibration. Therefore, it is possible to avoid a situation that the user did the density calibration but failed to perform the operation for determining the P/A coefficient, so that the P/A coefficient of the desired mass number cannot be determined.

Further, in the present invention, it is monitored whether the signal intensity of the mass number to be measured has entered the calibration range, while the voltage to be applied to the ion lens is changed so that the P/A coefficient is determined when the signal intensity of the mass number enters in the calibration range. According to this measurement method, it is possible to monitor securely that the signal intensity of the mass number to be a target has entered the calibration range, and the number of points of the voltage to be applied to the ion lens for measuring the P/A coefficient can be decreased to be much smaller than that in the system disclosed in U.S. Pat. No. 5,463,219. Therefore, the third object can be achieved.

In addition, according to an aspect of the present invention configured to achieve the first to third objects, measurement of the signal intensity for determining the P/A coefficient and the measurement of the sample to be measured are performed under the same measurement condition for each element. Therefore, there is a merit that it is not necessary to consider influence of a difference of incident energy into the ion detector between the measurements on the P/A coefficient.

A fourth object of the present invention is to provide means for estimating more precisely the P/A coefficient of a mass number for which the P/A coefficient is not determined in the given ICP-MS, without measurement for determining the P/A coefficient using a sample for P/A coefficient calibration in the case where a measured value is determined for the mass number.

In order to achieve the fourth object, the present invention estimates the unknown P/A coefficient by utilizing the fact that there is a correlation that can be well approximated by a certain function expression between P/A coefficient sequences determined for the same mass number, between a P/A coefficient set determined by measuring an arbitrary sample by an arbitrary TCP-MS for an arbitrary element and a P/A coefficient set determined by measuring the same sample as the sample or another arbitrary sample by the same ICP-MS or another arbitrary ICP-MS separately.

A fifth object of the present invention is to reduce a situation where the density of the desired mass number cannot be quantified because the P/A coefficient of the desired mass number is not determined. This object can be achieved, as described later, by the ICP-MS having both the configuration for achieving the first to third objects described above and the configuration for achieving the fourth object described above. The aspect of the present invention embodied by the configuration for achieving the first to third objects described above and the aspect of the present invention embodied by the configuration for achieving the fourth object described above have a close relationship in view of the fact that the effect can be achieved by a combination thereof.

In this specification, the P/A coefficient is determined for each mass number. This is because that the mass number to be used for measurement for each element can be usually determined in advance in the ICP-MS, so that at least the mass number measured in the density calibration can all be associated with a particular element. Therefore, when the P/A coefficient is determined for each of the mass numbers, it means that the P/A coefficient is prepared for every element to be measured.

As known well, the density calibration means to measure a signal intensity for one or more densities for each element of the mass number to be analyzed, namely to be quantified, so as to determine the density of the element from the measured signal intensity for the element, and to determine a calibration curve indicating a relationship between the density of the element and the signal intensity for each element from the density thereof and the measured signal intensity. The calibration curve can be determined by performing the density calibration one time. In this specification, in the case where it is desirable to distinguish the density calibration performed at one time from a density calibration performed at another time clearly, the density calibration performed at one time is particularly referred to as “one density calibration”.

### BRIEF DESCRIPTION OF THE DRAWINGS

In the accompanying drawings:

FIG. 1 is a block diagram of a conventional ICP-MS that can measure a pulse count value and an analog current value simultaneously or selectively;

FIG. 2 is a flow chart illustrating a process of a first embodiment of the present invention;

FIG. 3 is a flow chart illustrating P/A coefficient determining process according to the first embodiment of the present invention;

FIG. 4 illustrates an example of a working curve that can be determined as a result when the first embodiment of the present invention is performed;

FIGS. 5A, 5B, and 5C are graphs illustrating results of measurement for density calibration performed for each of standard density samples 1, 2, and 3 that are used in measurement for one density calibration in the first embodiment of the present invention. In the graph of FIG. 58, mass numbers having the P/A coefficients determined by using the standard density sample 1 are not plotted. Further, in the graph of FIG. 5C, mass numbers having the P/A coefficients determined by using the standard density samples 1 and 2 are not plotted;

FIG. 6 is a graph showing a process for determining the P/A coefficient from a signal determined by measurement for density calibration and a signal determined by measurement following adjustment of a voltage applied to an ion lens together with FIG. 5A according to the first embodiment of the present invention;

FIG. 7 is a flow chart illustrating a process of a second embodiment of the present invention;

FIG. 8 is a graph in which user P/A coefficients of five mass numbers (indicated by squares) and reference P/A coefficients of the same five mass numbers (indicated by solid black rhombuses) are plotted with respect to the mass numbers;

FIG. 9 is a graph in which the horizontal axis (x axis) and the vertical axis (y axis) represent the reference P/A coefficient and the user P/A coefficient, respectively, and (x, y) coordinates of the reference P/A coefficient (x) and the user P/A coefficient (y) are plotted with respect to the five mass numbers. The solid line curve indicates a quadratic curve approximating the plotted points;

FIG. 10 is a graph in which P/A coefficients estimated by the P/A coefficient estimation method according to the present invention with respect to some mass numbers in a certain ICP-MS (indicated by crosses) and P/A coefficients determined as a result of actual measurement for P/A coefficient determination with respect to the same mass numbers in the same ICP-MS (indicated by open circles) are plotted; and

FIG. 11 is a graph showing a P/A coefficient estimation method by conventional linear interpolation based on dependence of the P/A coefficient on the mass number.

### DETAILED DESCRIPTION OF THE PREFERRED EMBODIMENTS

A first aspect of the present invention is directed to a structure and a method for determining a P/A coefficient by utilizing conventionally-employed measurement of a standard density sample for generating a working curve. A second aspect of the present invention is directed to a P/A coefficient estimation method for estimating more precisely, in the case where a mass number for which a P/A coefficient is not determined exists, the P/A coefficient of the mass number on the basis of a correlation between two P/A coefficient sequences determined by different measurements in a given ICP-MS. Hereinafter, first and second embodiments exemplifying and embodying the first and second aspects of the present invention are described.

### 1. First Embodiment

The first aspect of the present invention can be performed in the conventional ICP-MS by software incorporated in the same, which becomes clearer from the description later. In this point, as understood from the description later, the ICP-MS in which the present invention is performed is equipped with voltage control means that is means for adjusting a voltage applied to an ion lens in accordance with a measured signal intensity to thereby adjust an ion transmission ratio of the ion lens. It is merely a design matter for a person skilled in the art to constitute the voltage control means by the ion lens voltage drive part 55 and the system control part 60 for controlling the ion lens voltage drive part 55, and to incorporate control software in the system control part GO, so as to adjust appropriately the voltage applied to the ion lens via the drive part 55.

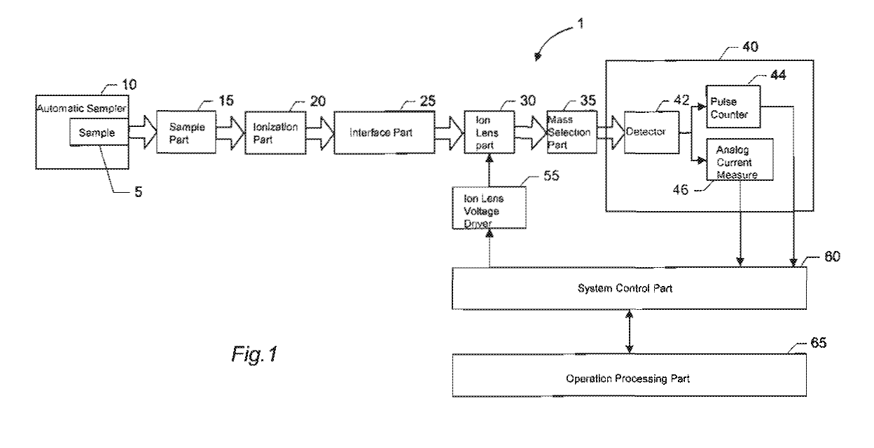

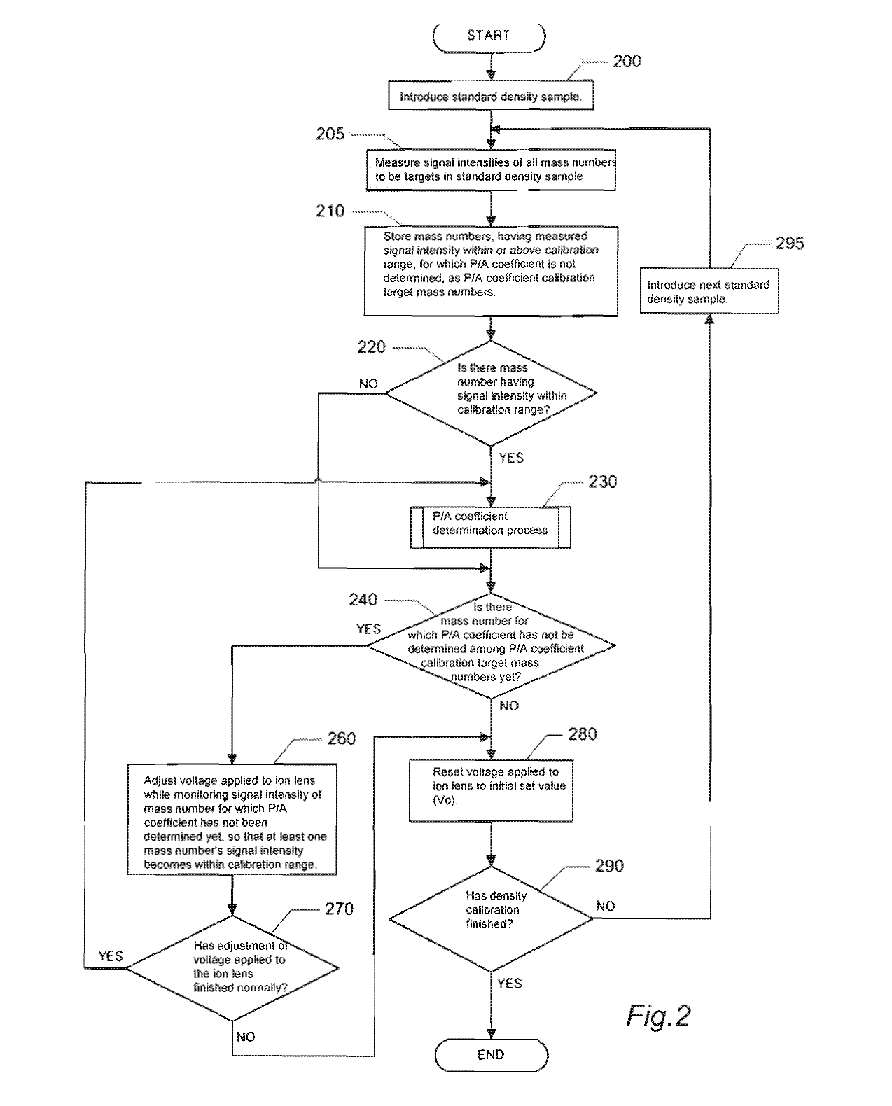

Therefore, with reference to a flowchart illustrated in FIG. 2, described next is operation when the present invention is applied to the conventional ICP-MS having the structure illustrated in FIG. 1 by reference numeral 1 as a whole, in which both the pulse count value and the analog current value can be measured simultaneously. Note that, in the ICP-MS in which this embodiment is embodied, it is supposed that the voltage applied to the ion lens is set to a predetermined initial value (V₀) when the measurement of a sample is started, similarly to the measurement for the conventional density calibration.

First, in Step 200, a standard density sample is introduced into the ICP-MS. In general, a predetermined standard density sample that is used for measurement for one density calibration is prepared as one or more standard density samples. The standard density samples constituting the predetermined standard density sample contain the same element, but the density of the same element is different among the standard density samples, and is selected so that the density of the element estimated to be contained in the sample to be measured is equal to or smaller than a maximum density of the standard density sample containing the element at the maximum density.

Here, this embodiment is described for the case where the following set of standard density samples 1 to 3 are used as the standard density sample to be used in measurement for one density calibration. The densities of elements contained in the standard density sample 1 are 10 ppb and 1 ppm, the densities of elements contained in the standard density sample 2 are 50 ppb and 5 ppm, and the densities of elements contained in the standard density sample 3 are 100 ppb and 10 ppm. In addition, the elements having the densities of 10 ppb, 50 ppb, and 100 ppb in the standard density samples are Be, Al, Ca, V, Cr, Mn, Fe, Co, Ni, Cu, Zn, As, Se, Mo, Ag, Cd, Sb, Ba, TI, Pb, Th, and U (having mass numbers of 9, 27, 93, 51, 53, 55, 57, 59, 60, 63, 66, 75, 82, 95, 107, 111, 121, 137, 205, 208, 232, and 238 amu, respectively). The elements having the densities of 1 ppm, 5 ppm, and 10 ppm are Na, Mg, K, Fe, and Sr (having mass numbers of 23, 24, 39, 56, 88 amu, respectively).

Also in this embodiment, similarly to the conventional measurement for one density calibration, the standard density samples are introduced into the ICP-MS in order of increasing density of element. Therefore, the standard density sample 1 is first introduced into the ICP-MS, and signal intensities of all mass numbers to be targets of the density calibration in the sample are measured in Step 205.

The signal intensities determined for the mass numbers in the sample are measured simultaneously as the pulse count value and the analog current value by the pulse counter 44 and the analog current measuring part 46 illustrated in FIG. 1. The measured values determined in this way are associated with corresponding mass numbers and are stored in a memory (not shown) in the operation processing part 65. Note that, the series of the processes from the introduction of the sample to obtaining of the measured data in the ICP-MS is performed not only in the density calibration but also in other occasions by the blocks controlled by the system control part 60. Such control and operation of the blocks are known well, and therefore detailed descriptions thereof are omitted.

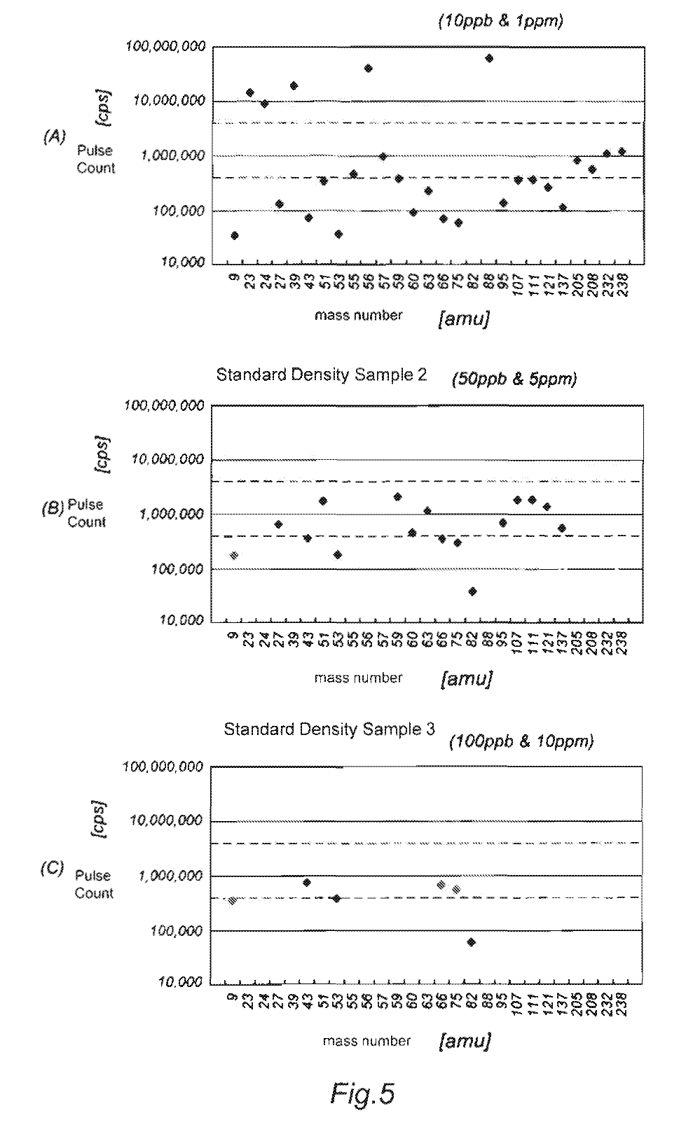

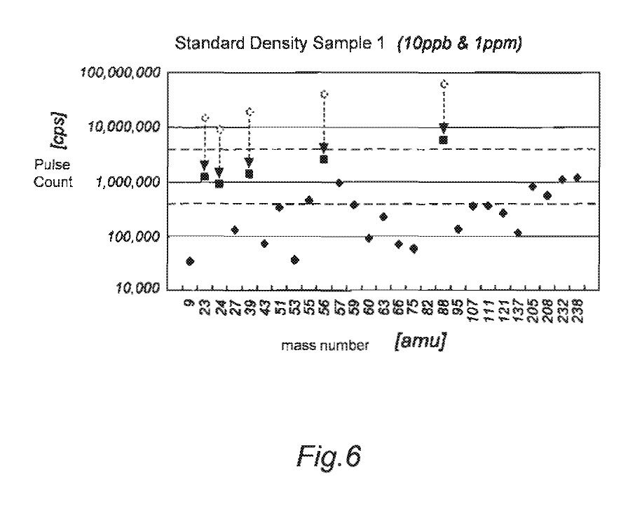

FIG. 5A illustrates signal intensities of the mass numbers in the standard density sample 1, which are measured as described above. Here, in FIGS. 5A to 5C and 6, for a simple description, the measured signal intensities in the signal intensity range above the calibration range are converted into the pulse count values. In the diagrams, the range enclosed by two dot lines having pulse count values of approximately 560 Kcps to 5.6 mcps is the calibration range.

Next, in Step 210, the system control part 60 discriminates a mass number having measured signal intensity within the calibration range and a mass number having measured signal intensity above the calibration range, and stores the mass numbers in the memory as mass numbers for which the P/A coefficient should be determined (hereinafter, referred to as P/A coefficient calibration target mass numbers).

Next, in Step 220, if there is a mass number for which the signal intensity is measured within the calibration range, the system control part 60 regards the mass as a P/A coefficient calibratable mass number and stores the signal intensity of the mass number measured in the calibration range (analog current value and pulse count value measured simultaneously) in the memory in association with the mass number. Then, the process proceeds to the P/A coefficient determining process 230 for determining the P/A coefficient from the analog current value and the pulse count value. If such mass number does not exist, the process proceeds to Step 240. In the measurement example illustrated in FIG. 5A, signal intensities of six mass numbers including the mass numbers 55, 57, 205, 208, 232, and 238 are in the calibration range. Therefore, these mass numbers are regarded as the P/A coefficient calibratable mass numbers, and the P/A coefficients of the six mass numbers are determined first in Step 230.

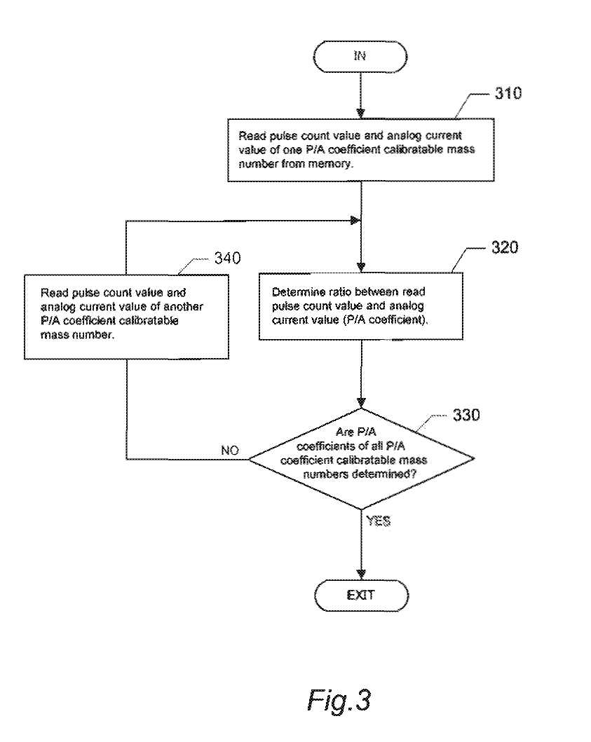

FIG. 3 is a flow chart illustrating the P/A coefficient determining process. In Step 310, the operation processing part 65 reads from the memory the pulse count value and the analog current value of one mass number among the P/A coefficient calibratable mass numbers discriminated to have the signal intensity within the calibration range. Next, in Step 320, a ratio between the read pulse count value and the analog current value (P/A coefficient) is determined. In Step 330, it is judged whether or not the P/A coefficient of every P/A coefficient calibratable mass number has been determined. If there is a P/A coefficient calibratable mass number for which the P/A coefficient has not been determined yet, the pulse count value and the analog current value of another P/A coefficient calibratable mass number are read from the memory in Step 340, and the P/A coefficient of the another mass number is determined from the values in Step 320. After that, in the same manner, the loop including Steps 320, 330, and 340 is repeated. When it is judged that the P/A coefficient is determined for every P/A coefficient calibratable mass number in Step 330, the process exits Step 230 (FIG. 2).

Referring back to FIG. 2, when the P/A coefficient determining process in Step 230 is finished, the process proceeds to Step 290, in which the system control part 60 judges whether or not there is a mass number for which the P/A coefficient has not been determined yet among the P/A coefficient calibration target mass numbers stored in the memory in Step 210. Here, when Step 240 is performed first time, the P/A coefficient is already determined in Step 230 as for every mass number discriminated to have signal intensity measured within the calibration range in Step 210 among the P/A coefficient calibration target mass numbers. Therefore, the mass number for which the P/A coefficient is not determined at this stage is the mass number discriminated to have the signal intensity above the calibration range in Step 210. On the other hand, when Step 240 is performed for the second time or later, the number of the mass numbers for which the P/A coefficient is not determined is decreased by the number of mass numbers for which the P/A coefficient is determined in Step 230 performed for the second time and later.

The mass number for which it is judged that the P/A coefficient is not determined in Step 240 means a mass number for which the signal intensity is not measured at all in the calibration range. Therefore, in this state, the P/A coefficient cannot be determined for the mass number. Therefore, when it is judged in Step 240 that there is such a mass number, the system control part 60 controls the ICP-MS in Step 260 so as to measure the signal intensity of every mass number for which the P/A coefficient is not determined yet among the P/A coefficient calibration target mass numbers. Then, the measured values are monitored, and a voltage applied to the ion lens is adjusted successively (via control of the ion lens voltage drive part 55) in the direction of increasing or decreasing the ion transmission ratio of the ion lens so that the signal intensity of at least one mass number among the measured values is measured in the calibration range. Here, the applied voltage is adjusted in the direction of increasing the transmission ratio of the ion lens in the case where the adjustment of the voltage applied to the ion lens in the direction of decreasing the transmission ratio of the ion lens causes the signal intensity that is measured above the calibration range in the measurement just before the adjustment to drop past and below the calibration range. In this way, the voltage applied to the ion lens is adjusted in the direction of increasing the transmission ratio of the ion lens so that the signal intensity is measured within the calibration range for the mass number for which the signal intensity has dropped from the region above the calibration range to the region below the calibration range without being measured within the calibration range by the adjustment of the voltage applied to the ion lens.

In Step 260, the mass number for which the signal intensity is measured within the calibration range is regarded as the P/A coefficient calibratable mass number by the adjustment of the voltage applied to the ion lens. Then, in the same manner as described above, in Step 230, the P/A coefficients of the mass numbers are determined from the measured values of the mass numbers when being measured within the calibration range. Here, the ion transmission ratio of the ion lens can be adjusted continuously between a point where the signal intensity measured for an arbitrary mass number becomes maximum and a point where the same becomes substantially zero by changing appropriately the voltage applied to the ion lens. Therefore, by repeating Steps 240, 260, and 230 appropriately, the signal intensity can be measured within the calibration range at least one time for each of the P/A coefficient calibration target mass numbers. Thus, the P/A coefficient can be determined. Note that, in Step 260, by measuring only the signal intensity of the mass number for which the P/A coefficient is not determined yet, it is avoided to redundantly measure the signal intensity of the mass number for which the P/A coefficient is once determined, namely to determine the P/A coefficient redundantly for the sample that is being measured. By combining the process with the process in Step 210 to be described later for the standard density samples 2 and 3, it is possible to avoid redundant measurement of the signal intensity in measurement of an arbitrary standard sample introduced for the same one density calibration, not only for the mass number for which the P/A coefficient is already determined from measurement of the standard sample but also for the mass number for which the P/A coefficient is already determined from measurement of another arbitrary standard density sample that is introduced for the same one density calibration. Therefore, it is possible to avoid redundant determination of the P/A coefficient of the same mass number for every standard density sample introduced for the same one density calibration.

Here, the process in Steps 230, 240, and 260 with respect to the standard density sample 1 is described. In the graph of FIG. 5A, the P/A coefficient calibration target mass numbers in the standard density sample 1 include eleven mass numbers of 23, 24, 39, 55, 56, 57, 88, 205, 208, 232, and 238. Among them, five mass numbers of 23, 24, 39, 56, and 88 exceed the calibration range. These five miss numbers are excluded from targets of the P/A coefficient determining process in Step 230 that is performed for the first time. Therefore, in the next Step 240, these five mass numbers are judged to be mass numbers for which the P/A coefficient is not determined. As a result, the process proceeds to Step 260. In Step 260, the system control part 60 adjusts a voltage applied to the ion lens via control of the ion lens voltage drive part 55 while monitoring signal intensities of the five mass numbers, so that the signal intensity of at least one mass number among the five mass numbers is measured within the calibration range. In the present example, in order that the signal intensity of at least one of the five mass numbers is within the calibration range, the voltage applied to the ion lens is adjusted in the direction of decreasing the ion transmission ratio of the ion lens. For that purpose, this embodiment adopts a method of adjusting the voltage applied to the ion lens so that the lowest signal intensity among the signal intensities of the five mass numbers becomes a predetermined level within the calibration range (e.g., approximately 1 Mcps).

The graph of FIG. 6 illustrates the signal intensities of the mass numbers plotted when the voltage applied to the ion lens in Step 260 is adjusted by a predetermined amount from the state of measurement of FIG. 5A, so that the signal intensity of element Mg with the mass number of 24 having the lowest signal intensity among the five mass numbers becomes approximately 1 Mcps.

In the graph of FIG. 6, the signal intensities of mass numbers except the rightmost mass number 88 among the five mass numbers 23, 24, 39, 56, and 88 having had the signal intensities above the calibration range in FIG. 5A are now within the calibration range. Therefore, the P/A coefficients can be determined for the mass numbers 23, 24, 39, and 56 at this time point, so in Step 260, these mass numbers are regarded as the P/A coefficient calibratable mass numbers.

Next, the process proceeds to Step 230 in which the system control part 60 determines P/A coefficients of the five P/A coefficient calibratable mass numbers by the operation processing part 65 in the same manner as described above.

After that, the process proceeds, to Step 240 in which it is judged whether or not there is any mass number for which the P/A coefficient is not determined yet among the P/A coefficient calibration target mass numbers. In the measurement example of FIG. 6, only the signal intensity of the mass number 88 still exceeds the calibration range. Therefore, the process proceeds to Step 260 in which the voltage applied to the ion lens is adjusted so that the signal intensity of the element having the mass number 88 becomes approximately 1 Mcps this time. After that, only the mass number 88 is regarded as the P/A coefficient calibratable mass number, so that the P/A coefficient of the element having the mass number 88 is determined in Step 230.

In this way, the loop of Steps 240, 260, 270, and 230 is repeated, so that the P/A coefficient is determined for each of the five mass numbers recognized by performing Step 240 for the first time. In addition, the P/A coefficients for six mass numbers 55, 57, 205, 208, 232, and 238 are also determined by performing Step 230 for the first time as described above. Finally, the P/A coefficient is determined for each of the eleven P/A coefficient calibration target mass numbers in the standard density sample 1.

Note that, Step 270 is a fault detection step. If it is not judged in the step that the adjustment of the voltage applied to the ion lens is finished correctly, it is regarded that an abnormal state has occurred in the measurement sequence, and the measurement process of the current sample is stopped.

After exiting the loop, the process proceeds to Step 280 in which the voltage applied to the ion lens is reset to the initial value V₀. After that, it is judged in Step 290 whether or not the density calibration is finished, namely whether or not the density calibration is finished for all mass numbers to be targets of the density calibration from the measured values of all standard density samples prepared for one density calibration. If the density calibration is not finished, the standard density sample having the next lowest density is introduced into the ICP-MS in Step 295, so that the same process is performed for the sample. In this example, the measurement is not performed for the standard density samples 2 and 3. Therefore, the process proceeds from Step 290 to Step 295 in which the standard density sample 2 is introduced into the ICP-MS, so that the process is started for the sample from Step 205 that is the measurement step for the density calibration similarly to the standard density sample 1.

FIG. 5B illustrates a result of the measurement performed for the standard density sample 2 in Step 205. In Step 205, signal intensities of all elements contained in the standard density sample 2 are actually measured, but it should be noted that measured values of mass numbers for which the P/A coefficient is already determined in the standard density sample 1 among the elements are not plotted in FIG. 5B. In addition, it is not necessary to determine the P/A coefficient for the mass numbers for which the P/A coefficient has been already determined in the standard density sample 1. Therefore, as described above, in order to avoid redundant determination of the P/A coefficient in the measurement of the standard density sample introduced for the same one density calibration, the mass numbers are excluded from the P/A coefficient calibration target mass numbers in Step 210. Therefore, they are excluded from targets of the P/A coefficient determining process 230 and the associated Steps 240 and 260. In the measurement example illustrated in FIG. 5B, the mass numbers 23, 24, 39, 55, 56, 57, 88, 205, 208, 232, and 238 are excluded from targets of the P/A coefficient determining process. Therefore, the P/A coefficient calibration target mass numbers recognized for the standard density sample 2 in Step 210 are only mass numbers having signal intensities within the calibration range illustrated as a region between two dot lines in FIG. 5B.

As understood from comparison between FIG. 5A and FIG. 58, some of the mass numbers having had the signal intensities below the calibration range (e.g., the mass number 27) in the measurement of the standard density sample 1 in Step 205 are raised to the inside of the calibration range in the measurement of the standard density sample 2 in Step 205. This is because the densities of the elements having the mass numbers in the standard density sample 2 are higher than densities thereof in the standard density sample 1. Therefore, the mass numbers in the calibration range (except mass numbers for which the P/A coefficient is already determined) are recognized as the P/A coefficient calibratable mass numbers in Step 220, so that the P/A coefficient determining process in Step 230 is performed for the mass numbers. On the other hand, in FIG. 58, there is no mass number having a signal intensity above the calibration range except for the mass numbers (not shown) for which the P/A coefficient is already determined. Therefore, Steps 260 and 270 are not performed for the standard density sample 2.

When the P/A coefficient is determined for each of the P/A coefficient calibration target mass numbers in the standard density sample 2, the process proceeds to Step 295 via Steps 240 and 280 (in this case, the voltage applied to the ion lens remains to be V₀ so that Step 280 may not be performed) and Step 290. The standard density sample 3 having the highest density is introduced into the ICP-MS in Step 295, and after that, similarly to the standard density sample 1, the process is started from Step 205 that is a measurement step for the density calibration.

FIG. 5C illustrates a result of the measurement performed for the standard density sample 3 in Step 205. In Step 205, signal intensities of all mass numbers included in the standard density sample 3 are actually measured, but it should be noted that measured values of mass numbers for which the P/A coefficient is already determined in the standard density samples 1 and 2 are not plotted in FIG. 5C. In addition, also for the standard density sample 3, the mass numbers for which the P/A coefficient is al ready determined in the standard density samples 1 and 2 are excluded from the P/A coefficient calibration target mass numbers in Step 210. Therefore, they are excluded from targets of the P/A coefficient determining process in Step 230. Therefore, the P/A coefficient calibration target mass numbers recognized for the standard density sample 3 in Step 210 are only mass numbers having signal intensities within the calibration range illustrated as a region between two dot lines in FIG. 5C.

As understood from comparison between FIG. 5B and FIG. 5C, some of the mass numbers having had the signal intensities below the calibration range (e.g., mass number 43) in the measurement of the standard density sample 2 in Step 205 are raised to the inside of the calibration range in the measurement of the standard density sample 3 in Step 205. This is because the densities of the elements having the mass numbers in the standard density sample 3 are higher than densities thereof in the standard density sample 2. Therefore, the mass numbers in the calibration range (except mass numbers for which the P/A coefficient is already determined) are recognized as the P/A coefficient calibratable mass numbers in Step 220, so that the P/A coefficient determining process in Step 230 is performed for the mass numbers. On the other hand, in FIG. 5C, there is no mass number having a signal intensity above the calibration range except for the mass numbers (not shown) for which the P/A coefficient is already determined. Therefore, Step 260 and 270 are not performed for the standard density sample 3, too.

Note that, there is no mass number having the signal intensity above the calibration range in each of the standard density samples 2 and 3 as measurement targets this time, except for the mass numbers for which the P/A coefficient is already determined, as a result of measurement in Step 205. However, there may be a case where there is a mass number having a signal intensity above the calibration range besides the mass number for which the P/A coefficient is already determined, depending on the mass numbers contained in the standard density samples and/or the density of the element of the mass number, in Step 290 that is performed for the first time. In this case, the loop of Step 240, 260, 270, and 230 is performed for the mass numbers in the standard density sample 2 and/or 3 above the calibration range similarly to the above description for the standard density sample 1.

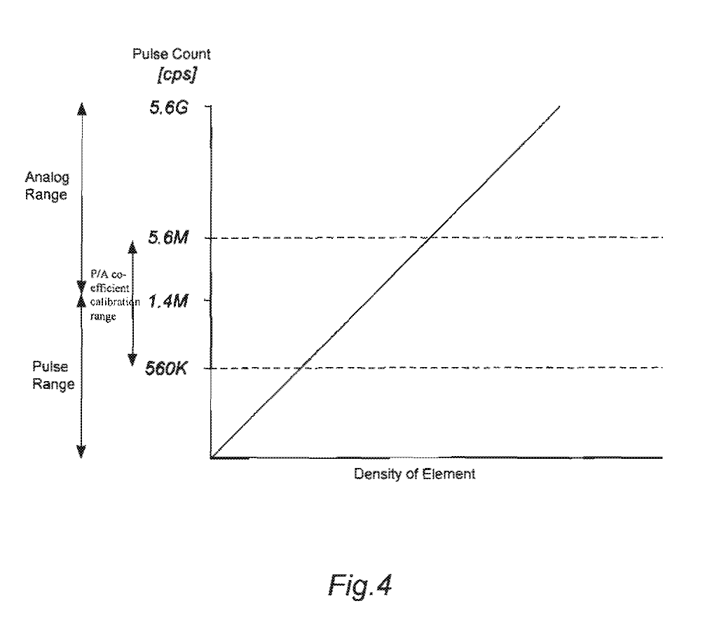

In this way, when the P/A coefficients of all the P/A coefficient calibration target mass numbers are determined by the measurement of the three standard density samples, the measured value of the signal intensity at each density is determined as both a pulse count value and an analog current value for each of all the P/A coefficient calibration target mass numbers by the measurement in Steps 205 and 260. Therefore, the effective analog current values measured in the signal intensity range within and above the calibration range are multiplied to the P/A coefficient determined in this way, so that the analog current value in the range can be converted into the effective pulse count value. Therefore, among the measured values determined for each of the standard density samples 1 to 3 in Step 205, the analog current value measured in the signal intensity range above a predetermined signal intensity that is set within the calibration range is converted into the pulse count value in this way and is plotted, while a pulse count value is plotted for the measured value determined in the signal intensity range below the predetermined signal intensity, with respect to each density of each element of the mass number in the standard density samples 1 to 3. Then a calibration curve connecting the plotted points (that is usually a straight line) is determined, so that a working curve can be drawn over the pulse range to the analog range as illustrated in FIG. 4, in which the signal intensity is expressed only by pulse count values.

Further, in the case where the measurement of each of standard samples introduced for one density calibration is finished for every mass number to be the target of the P/A coefficient determination, and thereafter another new measurement is performed for one density calibration, the P/A coefficient is determined again for every mass number to be the target of the P/A coefficient determination. In other words, every time when new measurement for one density calibration is performed, the P/A coefficients that have already been determined in relation with any other one density calibration are all reset.

The series of processes for the P/A coefficient determination described above with reference to FIG. 2 is performed by operating individual blocks illustrated in FIG. 1 on the basis of control by the software incorporated in the system control part 60. In particular, the P/A coefficient determining process in Step 230 can be performed by the operation processing part 65. Therefore, the series of processes performed after the user introduces the standard density sample into the ICP-MS can be performed automatically. In this point, each of the system control part 60 and the operation processing part 65 can be typically constructed of a microprocessor and a memory that the microprocessor can read and write. Therefore, the processes of the P/A coefficient determination in Step 230 and the related Steps 240, 260, and 270 can be performed by one of the system control part 60 and the operation processing part 65 or may be performed and shared by both of them appropriately depending on design requirements, as a design matter.

Further, the P/A coefficient is not determined for a mass number for which the signal intensity has been measured only in the pulse range below the calibration range even by the adjustment of the voltage applied to the ion lens because of low density in the standard density sample. It is usually expected that the signal intensity is measured for the mass number originally by the pulse count value. Therefore, there is little practical problem even if the P/A coefficient cannot be determined for such mass number. However, there is a case where the estimated value of the P/A coefficient can be determined also for such mass numbers by using the P/A coefficient estimation method of the present invention to be described later in the second embodiment.

In addition, although a plurality of samples are used as the standard density sample for one density calibration in the above description, it is possible to use only one standard density sample having density equal to or larger than the density expected for each of the desired mass numbers in the sample to be measured. In this case, too, the process can be performed in the same manner as described above for the standard density sample 1.

In addition, the above description describes the case where this embodiment is per formed by the ICP-MS apparatus that can measure both the pulse count value and the analog current value at the same time. However, the present invention can be performed also by the ICP-MS having a structure of measuring the pulse count value and the analog current value selectively, in the same manner, though some measurement error may be generated due to such switching.

In addition, according to the above-mentioned P/A coefficient determining method of the present invention, density information of each element can also be determined at the same time as the determination of the P/A coefficient. Therefore, even if a signal that is used for determining a P/A coefficient of an element of a certain mass number is affected by molecular ion interference, the degree of effect can be monitored. Therefore, if the degree of effect exceeds a predetermined standard, in the measurement for a plurality of standard samples introduced for the same one density calibration, the P/A coefficient determined from the measured value of the standard density sample containing higher density of element of the mass number is adopted with a priority, so that the degree of effect of the molecular ion interference on the element of the mass number can be reduced more. In this way, in order to obtain the P/A coefficient from the measured value of the standard density sample having higher density, even if the mass number is a mass number for which the P/A coefficient has already been determined in the process described above with reference to FIG. 2, as to the mass number for which it is judged that influence of the molecular ion interference cannot be ignored, the signal intensity of the mass number in another standard density sample containing higher density of element of the mass number may be measured within the calibration range so that the P/A coefficient of the mass number can be determined again. Note that, the degree of the influence of the molecular ion can be known from the signal intensity at zero density in the working curve of the element, which is generated from the signal intensity measured values of at least two different densities for the element of the mass number.

As described above, the case where the present invention is applied to the typical ICP-MS having the structure of measuring both the pulse count value and the analog current value is described. However, it is clear that the present invention can generally be applied to any ICP-MS having a structure in which the ion measuring part (e.g., reference numeral 90 in FIG. 1) for detecting and measuring the signal intensity covers the signal intensity range having higher signal intensity and the signal intensity range having lower signal intensity by two different measurement methods, in order to support a wide dynamic range of the measured signal of the ICP-MS, where the two measurement methods have an overlapping effective signal intensity range.

In other words, in the first embodiment described above with reference to FIG. 2, by replacing the pulse count value and the analog current value with one and the other of measured values measured by the above-mentioned two measurement methods, a conversion coefficient between them can be determined similarly to the first embodiment. More specifically, when the standard density sample for density calibration is measured, a ratio between a measured value of one method and a measured value of the other method measured in the calibration range that is the overlapping signal intensity range in which the measured values of the measurement methods are both effective is calculated, and/or in accordance with necessity, after the ion transmission ratio of the ion lens is adjusted by adjusting the voltage applied to the ion lens so that the signal intensity can be determined within the calibration range, a ratio between a measured value of one method and a measured value of the other method, which are measured in the calibration range, is calculated. In this manner, the one measured value can be converted into the other measured value. The same is true for conversion in the opposite direction.

Thus, in the measurement of the standard density sample introduced into the ICP-MS for one density calibration, it is possible to obtain the conversion coefficient from one measured value of one measurement method and one measured value of the other measurement method corresponding to the same signal intensity in the calibration range, for each of the mass numbers to be targets of determination of the conversion coefficient. Using the conversion coefficient, it is possible to convert the measured value that is measured by one measurement method corresponding to any signal intensity into a measured value corresponding to the signal intensity to be measured by the other measurement method, for each of the mass numbers, namely to perform “one point calibration” of the conversion coefficient.

### 2. Second Embodiment

The P/A coefficient estimation method according to the present invention utilizes the above-mentioned fact that there is a correlation that can be approximated well by a certain function expression between the P/A coefficient sequences determined from different measurements with respect to the same mass number, to thereby estimate an unknown P/A coefficient.

In this embodiment as an embodiment of the present invention, in a given ICP-MS, P/A coefficients of k (k≧1) different mass numbers m₁, m₂, . . . , and mₖ in the sample to be measured (hereinafter, referred to as user P/A coefficients) are determined to be y₁, y₂, . . . , and yₖ, respectively. If a P/A coefficient of any mass number a except the mass numbers in the sample to be measured is not determined, the P/A coefficient in the mass number a is estimated as follows.

i) Store P/A coefficients determined in advance, for each of as many as possible mass numbers including the k mass numbers and the mass number a, which can be targets of measurement, preferably all mass numbers (hereinafter, referred to as reference P/A coefficients) in the given ICP-MS.

ii) Determine a function expression y=f(x) that expresses an appropriate straight line or curve relationship indicating a relationship between the user P/A coefficient sets (y₁, y₂, . . . , yₖ) and corresponding subsets (x₁, x₂, . . . , xₖ) determined respectively for mass numbers m₁, m₂, . . . , mₖ that are the same as k mass numbers among the reference P/A coefficient sets.

iii) Set y determined by substituting the reference P/A coefficient of the mass number α stored in the given ICP-MS into x in y=f(x) as an estimated value of the P/A coefficient of the mass number a in the given ICP-MS.

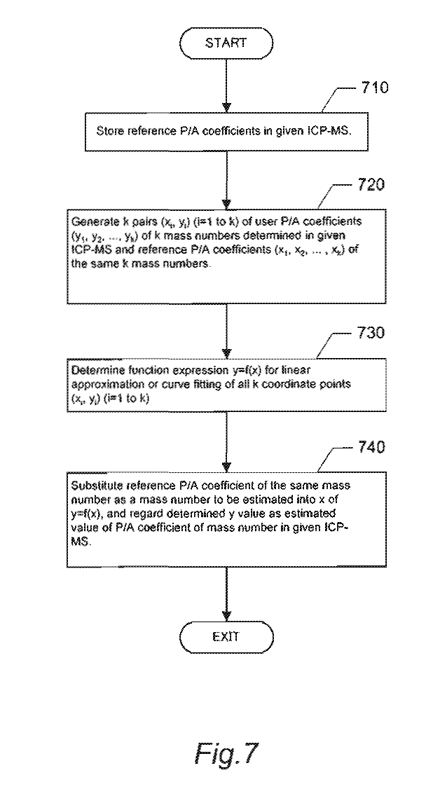

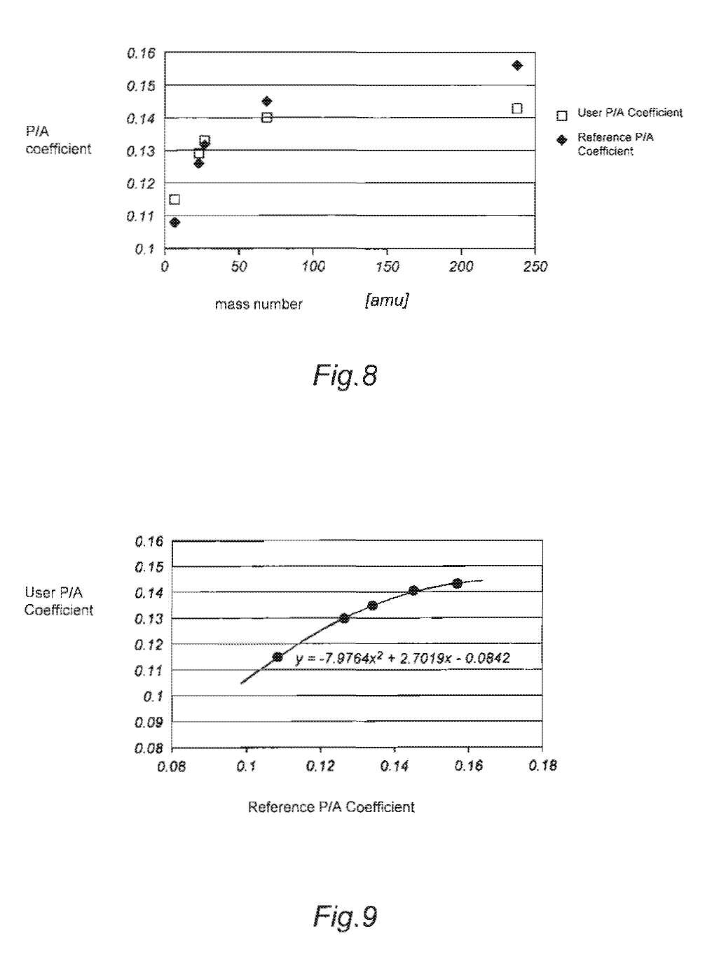

Hereinafter, operation in the case where the P/A coefficient estimation method of this embodiment is performed in the given ICP-MS having the conventional structure illustrated in FIG. 1 is described with reference to the flowchart illustrated in FIG. 7. This time, when the sample to be measured is measured, the P/A coefficients of five different mass numbers (i.e., k=5) determined by performing the conventional P/A coefficient determining method using a predetermined sample for P/A coefficient calibration are regarded as the user P/A coefficients (however, this time, as described later, in order to exemplify that estimation accuracy of the P/A coefficient according to the present invention is good, the user P/A coefficients of mass numbers besides the five mass numbers are also determined actually). Specifically, the five mass numbers are 7, 23, 27, 69, and 238 amu, and the user P/A coefficients thereof are determined to be 0.115151, 0.129762, 0.133808, 0.140516, and 0.14315, respectively (hereinafter, referred to as y₁, y₂, y₃, y₄ and y₅, respectively). Each of the five user P/A coefficients is associated with a corresponding mass number and is stored in the memory of the operation processing part 65 in the given ICP-MS. The five points indicated by squares in the graph of FIG. 8 are points where the five user P/A coefficients determined for the five mass numbers are plotted.

First, in Step 710, the P/A coefficients determined in advance for all mass numbers that can be targets of measurement including the five mass numbers are stored in the memory in the operation processing part 65 of the given ICP-MS as the reference P/A coefficients. The reference P/A coefficient can be determined by measuring a predetermined sample for P/A coefficient calibration in the given ICP-MS similarly to the conventional method, or by measuring a predetermined standard density sample in accordance with the P/A coefficient determining method of the present invention described with reference to the first embodiment described above. The five points of black rhombuses in the graph of FIG. 8 are plotted points corresponding to the reference P/A coefficients of the same five mass numbers as those for which the five user P/A coefficients are determined among the reference P/A coefficients determined as described above (which are 0.108972, 0.126415, 0.132952, 0.14518, and 0.156814, and hereinafter, referred to as x₁, x₂, x₃, x₄, and x₅, respectively).

Next, in Step 720, the operation processing part 65 reads out the five user P/A coefficients y₁, y₂, y₃, y₄, and y₅, and the reference P/A coefficients x₁, x₂, x₃, x₄, and x₅ corresponding to the user P/A coefficients from the memory of the operation processing part 65 so as to generate five data pairs (xᵢ, yᵢ) (i=1 to 5). The five points of dots in the graph of FIG. 9 are (x, y) coordinate points of the reference P/A coefficient (x) and the user P/A coefficient (y) in the plane having the horizontal axis (x axis) and the vertical axis (y axis) to represent the reference P/A coefficient and the user P/A coefficient, respectively, in which the five mass numbers are plotted. It may be understood from the plotted coordinate points that there is a relationship between the reference P/A coefficient sequence and the user P/A coefficient sequence, which can be approximated by a particular curve.

Next, in Step 730, the operation processing part 65 determines the function expression expressing a straight line or a curve that fits best the set of the coordinate points, by using a known approximation method such as multinomial approximation. The curve displayed by the solid line in FIG. 9 is a quadratic curve determined by using quadratic polynomial approximation based on least squares method with respect to the five coordinate points, and the function expression is determined to be y=−7.9764x₂+2.7019x−0.0842.

Next, in Step 740, using the function expression determined as described above, the P/A coefficient is estimated for a desired mass number that is not determined by the measurement for the P/A coefficient determination in the given ICP-MS (corresponding to the mass number for which the P/A coefficient is required to be estimated among the mass numbers for which the P/A coefficients are not determined in the sample to be measured). The reference P/A coefficient set can be determined so as to cover all the mass numbers to be targets of the measurement. Therefore, the reference P/A coefficient set usually includes also the reference P/A coefficient of the desired mass number for which the P/A coefficient is required to be estimated in the sample to be measured. Therefore, a y value determined by substituting the value of the reference P/A coefficient of the desired mass number as x into the above-mentioned function expression is regarded as the estimated value of the P/A coefficient of the desired mass number that is measured or is to be measured by the given ICP-MS.

As an example, a case of estimating the P/A coefficient of the mass number 133 is described. The reference P/A coefficient of the mass number 133 is determined to be 0.150771 and is stored in the memory of the operation processing part 65 of the given ICP-MS as described above. The operation processing part 65 reads out the reference P/A coefficient of the mass number 133 from the memory and substitutes the reference P/A coefficient as x into the function expression of y=−7.9764x₂+2.7019x−0.0842 so as to calculate a value of y. The operation processing part 65 determines the calculated value of y (i.e., 0.14185 in this example) as the estimated value of the P/A coefficient of the mass number 133 in the user ICP-MS. On the other hand, the P/A coefficient of the mass number 133 determined together with the five user P/A coefficients is 0.142044.

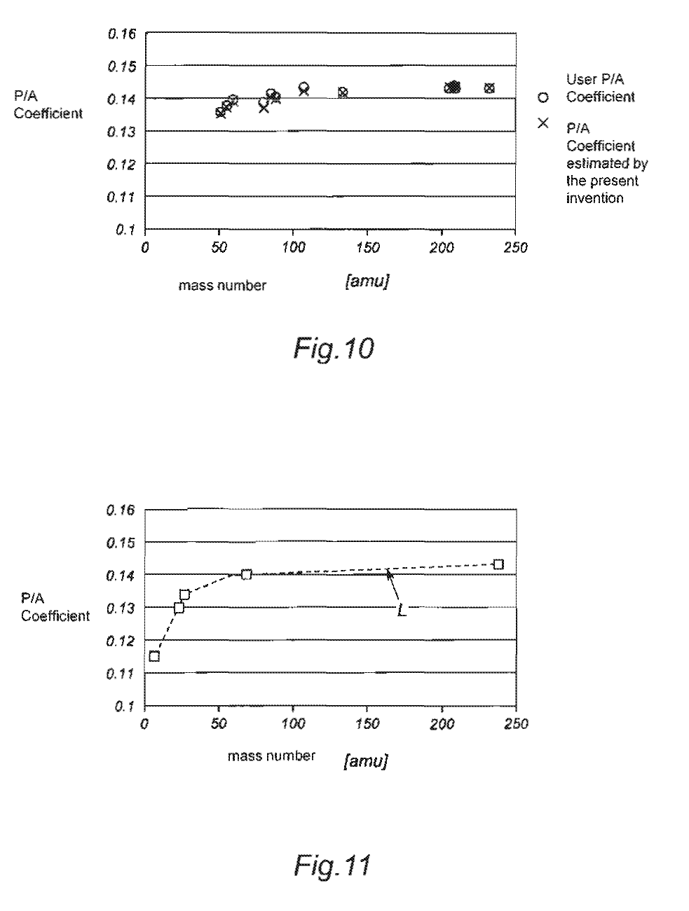

FIG. 10 is a graph in which the user P/A coefficients of other mass numbers determined together with the P/A coefficients of the five mass numbers are plotted with open circles by performing the conventional P/A coefficient determining method as described above when the sample to be measured is measured in the given ICP-MS, and the P/A coefficients estimated by the P/A coefficient estimation method for the same mass numbers are plotted with crosses. From this graph, it is understood that it is possible to obtain the estimated value approximated to be the P/A coefficients that would be actually determined from the measured signal intensity value for the P/A coefficient determination according to this P/A coefficient estimation method.

Although the case where k=5, namely there are five user P/A coefficients, is described above, the P/A coefficient estimation method of the present invention can be applied to the case where another number of user P/A coefficients are determined. For instance, in the case where k=1, namely only one user P/A coefficient is determined, the relationship with the corresponding reference P/A coefficient is determined to be a proportional relationship so that the determined function expression becomes an equation corresponding to a straight line passing through the origin. The function expression expressing the relationship with the corresponding reference P/A coefficient becomes a linear polynomial expression when k=2 holds, while it becomes a quadratic polynomial expression in general when k=3 holds.

In this way, according to the P/A coefficient estimation method of the present invention, even if there is a mass number for which the P/A coefficient of the sample to be measured is not determined in an arbitrary ICP-MS, the P/A coefficient of the mass number can be relatively correctly estimated.

The series of processes including the above-mentioned multinomial approximation can be per formed by software incorporated in the operation processing part 65. Alternatively, the series of processes may be performed by one of the system control part 60 and the operation processing part 65, or may be performed and shared by both of them appropriately, depending on design requirements.

The reference P/A coefficient that is used in this embodiment may be determined by other methods than that described above, for example, by measuring a predetermined sample for P/A coefficient calibration similarly to the conventional method in another ICP-MS, or by measuring a predetermined standard density sample in accordance with the present invention described above with reference to the first embodiment. In either case, it is possible to use the sample for determining the reference P/A coefficient, which contains as many elements as possible, preferably elements of all mass numbers that can be targets of the P/A coefficient determination, and has a density necessary for determining the effective P/A coefficient for each of the mass numbers. Further, when using, in the given ICP-MS, the reference P/A coefficient determined in another ICP-MS, it is possible to obtain the reference P/A coefficient having higher reliability by preparing a plurality of other ICP-MS's and by using an average value of the P/A coefficients determined for mass numbers by the plurality of ICP-MS's for each mass number as the reference P/A coefficient of each mass number. Thus, it can be expected that the P/A coefficient estimated value having higher reliability can be determined.

In addition, the user P/A coefficient is determined from the measured value of the predetermined sample for P/A coefficient calibration measured by the given ICP-MS as described above in this embodiment. However, in the given ICP-MS, the user P/A coefficient may be determined from the measured value of the predetermined standard density sample according to the present invention described above with reference to the first embodiment.

In addition, as described above with reference to the first and second embodiments, each of the operation processes in the P/A coefficient determining method and the P/A coefficient estimation method in the present invention can be performed by software incorporated in the system control part 60 and/or the operation processing part 65 disposed in the ICP-MS. However, the signal intensity data measured by the ICP-MS may be transmitted to an external computing device such as a personal computer disposed externally, so that the operation process can be performed by the computing device.

Finally, when both the P/A coefficient determination means of the present invention described above with reference to the first embodiment and the P/A coefficient estimation means of the present invention described above with reference to the second embodiment are incorporated in one ICP-MS, as described above, possibility that the P/A coefficient of a desired mass number can be estimated can be improved to be higher than that in the case where the conventional ICP-MS is used. In other words, according to the P/A coefficient determination means of the present invention, even if the user forgot to determine the P/A coefficient, the user only has to operate for the density calibration. With this, in general, the P/A coefficient of at least one mass number in the standard density sample introduced into the ICP-MS for the density calibration can be determined automatically. By using the P/A coefficient estimation means of the present invention for at least one mass number, the P/A coefficient of the desired mass number can be estimated. On the other hand, according to a combination of the conventional P/A coefficient determining method and the conventional P/A coefficient estimation method described above, if the user skipped the operation for the P/A coefficient determination by mistake or intentionally, the P/A coefficient cannot be determined for any of the mass numbers in the sample to be measured. Therefore, the P/A coefficient of the desired mass number cannot be estimated.

Although the present invention is described above with reference to the particular embodiments so that the present invention can be understood sufficiently, it is clear for a skilled person in the art that specific details are not necessary for embodying the present invention. The above description about the particular embodiments of the present invention is described for exemplification and illustration. It is not intended not only to be all-inclusive description of the present invention by the particular embodiments or to limit the present invention to the disclosed embodiments. In view of the above-mentioned description, it is clear that various modifications and deformations can be performed. It is intended that the scope of the present invention be defined by the attached claims and equivalent thereof.

What is claimed is:

1. An inductively coupled plasma mass spectroscopy apparatus, comprising:
a sample input configured to introduce a sample to be measured;
an ionizer configured to ionize an element in the sample;
an ion lens into which the ionized element is provided, wherein the ion lens is configured to focus the ionized element;
a mass analyzer configured to segregate the ionized element;
an ion measuring part configured to measure a signal intensity corresponding to a number of ions having a mass number segregated by the mass analyzer as a pulse count value and an analog current value; and
an operation processor configured to determine a pulse-to-analog (P/A) coefficient for converting the analog current value into the pulse count value from the analog current value measured by the ion measuring part and the corresponding pulse count value, wherein the operation processor is configured to determine the P/A coefficient of the mass number from the analog current value and the pulse count value corresponding to the signal intensity of the mass number.

2. An inductively coupled plasma mass spectroscopy apparatus as claimed in claim 1, wherein the signal intensity of the mass number is measured for the mass number corresponding to each element in a standard density sample introduced into the inductively coupled plasma mass spectroscopy apparatus for density calibration.

3. An inductively coupled plasma mass spectroscopy apparatus according to claim 1, further comprising:
first means for discriminating the mass number for which the signal intensity measured in the measurement for density calibration is within a calibration range from another mass number for which the signal intensity is above the calibration range;
means for storing the mass number that is discriminated by the first means for discriminating that the signal intensity is above the calibration range;
means for adjusting a voltage applied to the ion lens in a direction of decreasing or increasing a transmission ratio of the ion lens until the signal intensity of at least one of the mass numbers stored in the means for storing is measured within the calibration range, wherein the adjusting is repeated until the signal intensity of each of the mass numbers is measured at least one time within the calibration range; and
second means for discriminating the mass number among the mass numbers stored in the means for storing for which the signal intensity measured in each adjustment of the voltage applied to the ion lens by the means for adjusting the voltage is within the calibration range, wherein: the operation processor is configured to determine the P/A coefficient of the mass number from the pulse count value and the analog current value corresponding to the signal intensity with respect to the mass number discriminated to have the signal intensity within the calibration range by the first means for discriminating; and the operation processor is further configured to determine the P/A coefficient of the mass number from the pulse count value and the analog current value corresponding to the signal intensity, with respect to the mass number discriminated to have the signal intensity within the calibration range by the second means for discriminating in each adjustment of the applied voltage.

4. An inductively coupled plasma mass spectroscopy apparatus according to claim 1, further comprising means for controlling the operation processor to not determine the P/A coefficient for the mass number for which the P/A coefficient has been once determined among the mass numbers stored in the means for storing.

5. An inductively coupled plasma mass spectroscopy apparatus according to claim 3, wherein the means for controlling further controls the inductively coupled plasma mass spectroscopy apparatus to perform automatically a series of processes from the measurement for density calibration performed on the standard density sample to the determination of the P/A coefficients of all the mass numbers stored in the means for storing.

6. A method of determining a pulse-to-analog (P/A) coefficient for converting an analog current value into a pulse count value in an inductively coupled plasma mass spectroscopy apparatus configured to generate the pulse count value and the analog current value as a signal intensity indicating a density of an element in a sample to be measured, the method comprising:
introducing the sample to be measured;
ionizing an element in the sample to be measured;
focusing ions of the ionized element;
segregating the ions after the focusing for each mass number;
measuring a signal intensity corresponding to a number of ions of the mass number segregated as a pulse count value and an analog current value; and
determining the P/A coefficient of the mass number from the analog current value and the pulse count value measured for the mass number.

7. A method according to claim 6, wherein:
the inductively coupled plasma mass spectroscopy apparatus further comprises means for controlling a voltage to be applied to the ion lens; and
the determining the P/A coefficient comprises:
measuring the signal intensity of the mass number included in the standard density sample in the measurement for density calibration with respect to the standard density sample;
discriminating a mass number having the signal intensity within a calibration range and a mass number having the signal intensity above the calibration range among mass numbers for which the signal intensity has been measured;
storing the mass number that is discriminated to have the signal intensity above the calibration range in the discriminating of the mass number;
determining the P/A coefficient of the mass number from the pulse count value and the analog current value corresponding to the signal intensity with respect to the mass number that is discriminated to have the signal intensity within the calibration range in the discriminating of the mass number;
adjusting the voltage applied to an ion lens in a direction of decreasing or increasing a transmission ratio of the ion lens until the signal intensity of at least one of all the mass numbers stored in the storing step is measured within the calibration range by the means for controlling a voltage, and repeating the adjustment until the signal intensity of each of all the mass numbers is measured at least one time within the calibration range; and
a step of performing the following steps every time the applied voltage is adjusted in the step of adjusting the applied voltage, the steps including:
a second measurement step of measuring a signal intensity of the mass number stored in the storing step;
a second discrimination step of discriminating a mass number having the signal intensity measured in the second measurement step within the calibration range; and
a second P/A coefficient determination step of determining a P/A coefficient of the mass number from the pulse count value and the analog current value corresponding to the signal intensity measured in the second measurement step with respect to the mass number discriminated in the second discrimination step.

8. A method according to claim 6, wherein the P/A coefficient is not determined for the mass number for which the P/A coefficient has been once determined in one of the first P/A coefficient determination step and the second P/A coefficient determination step.

9. A method according to claim 7, wherein a series of processes from the measurement for density calibration performed on the standard density sample to determination of the P/A coefficients of all the mass numbers stored in the storing step is automatically performed.

10. A computer readable medium having a computer readable program code embodied therein, the computer readable program code adapted to be executed to implement a method of determining a coefficient for converting an analog current value into a pulse count value in an inductively coupled plasma mass spectroscopy apparatus configured to generate the pulse count value and the analog current value as a signal intensity indicating a density of an element in a sample to be measured, the method comprising:
introducing the sample to be measured;
ionizing an element in the sample to be measured;
introducing the ionized element;
focusing ions;
segregating the ions after the focusing for each mass number;
measuring a signal intensity corresponding to a number of ions of the mass number segregated as a pulse count value and an analog current value; and
determining the coefficient of the mass number from the analog current value and the pulse count value measured for the mass number.

11. A computer readable medium as claimed in claim 10, wherein:
the inductively coupled plasma mass spectroscopy apparatus further comprises means for controlling a voltage to be applied to the ion lens; and
the determining the coefficient comprises:
measuring the signal intensity of the mass number included in the standard density sample in the measurement for density calibration with respect to the standard density sample;
discriminating a mass number having the signal intensity within a calibration range and a mass number having the signal intensity above the calibration range among mass numbers for which the signal intensity has been measured;
storing the mass number that is discriminated to have the signal intensity above the calibration range in the discriminating of the mass number;
determining the P/A coefficient of the mass number from the pulse count value and the analog current value corresponding to the signal intensity with respect to the mass number that is discriminated to have the signal intensity within the calibration range in the discriminating of the mass number;
adjusting the voltage applied to an ion lens in a direction of decreasing or increasing a transmission ratio of the ion lens until the signal intensity of at least one of all the mass numbers stored in the storing step is measured within the calibration range by the means for controlling a voltage, and repeating the adjustment until the signal intensity of each of all the mass numbers is measured at least one time within the calibration range; and
a step of performing the following steps every time the applied voltage is adjusted in the step of adjusting the applied voltage, the steps including:
a second measurement step of measuring a signal intensity of the mass number stored in the storing step;
a second discrimination step of discriminating a mass number having the signal intensity measured in the second measurement step within the calibration range; and
a second P/A coefficient determination step of determining a P/A coefficient of the mass number from the pulse count value and the analog current value corresponding to the signal intensity measured in the second measurement step with respect to the mass number discriminated in the second discrimination step.

12. A computer readable medium according to claim 10, wherein the P/A coefficient is not determined for the mass number for which the P/A coefficient has been once determined in one of the first P/A coefficient determination step and the second P/A coefficient determination step.

13. A computer readable medium according to claim 10, wherein a series of processes from the measurement for density calibration performed on the standard density sample to determination of the P/A coefficients of all the mass numbers stored in the storing step is automatically performed.

14. An inductively coupled plasma mass spectroscopy apparatus, comprising:
a sample input;
an ionizer configured to ionize an element from the sample input;
an ion lens into configured to focus the ionized element;
means for controlling a voltage to be applied to the ion lens;
a mass analyzer for configured to segregate the ions focused by the ion lens for each mass number;
an ion measuring part configured to measure a signal intensity corresponding to a number of ions of the mass number segregated by the mass analyzer by a first method and a second method that is different type from the first method; and
an operation processor configured to determine a conversion coefficient for converting any measured value determined by the first method to a corresponding measured value to be determined by the second method, from measured values measured by the first method and the second method, for each mass number with respect to a signal intensity within a calibration range that is an overlapping range of signal intensity ranges in which the measurement can be performed by the first method and the second method,
the inductively coupled plasma mass spectroscopy apparatus configured to:
i) determine the conversion coefficient by the operation processor from the measured value corresponding to the signal intensity measured by the first method and the second method in the ion measuring part for a mass number having the signal intensity within the calibration range, which is measured by the ion measuring part for density calibration with respect to the mass number corresponding to each element in a standard density sample introduced into the inductively coupled plasma mass spectroscopy apparatus for the density calibration; and
ii) determine the conversion coefficient by the operation processor from the measured value corresponding to the signal intensity measured by the first method and the second method in the ion measuring part after the means for controlling the voltage adjusts an ion transmission ratio of the ion lens by changing the voltage applied to the ion lens so that the signal intensity of each of all mass numbers is within the calibration range at least one time for a mass number having the signal intensity above the calibration range, which is measured by the ion measuring part for the density calibration with respect to the mass number corresponding to each element in the standard density sample introduced into the inductively coupled plasma mass spectroscopy apparatus for the density calibration,
whereby a sample other than the standard density sample is not necessary as a sample for determining a coefficient of the mass number.

15. A method of determining a conversion coefficient for converting a measured value determined by a first method into a corresponding measured value to be determined by a second method that is of a different type from the first method in an inductively coupled plasma mass spectroscopy apparatus that is configured to measure a signal intensity indicating a density of an element in a sample to be measured by the first method and the second method,
the inductively coupled plasma mass spectroscopy apparatus comprising:
a sample input for introducing the sample to be measured;
an ionizer for ionizing an element in the sample to be measured introduced from the sample input;
an interface for introducing the ionized element;
an ion lens into which the ionized element is introduced from the interface and which includes an ion lens configured to focus ions that have passed through the interface;
means for controlling a voltage to be applied to the ion lens;
a mass analyzer configured to segregate the ions focused by the ion lens for each mass number;
an ion measuring part configured to measure the signal intensity corresponding to a number of ions of the mass number segregated by the mass analyzer by the first method and the second method; and
an operation processor configured to determine the conversion coefficient from the measured values determined by the first method and the second method for each mass number with respect to a signal intensity within a calibration range that is an overlapping range of signal intensity ranges in which the measurement can be performed by the first method and the second method,
the method comprising determining the conversion coefficient from:
i) a measured value corresponding to the signal intensity determined by the first method and the second method for a mass number having the signal intensity within the calibration range, which is determined for density calibration with respect to a mass number corresponding to each element in a standard density sample introduced to the inductively coupled plasma mass spectroscopy apparatus for the density calibration; and
ii) a measured value corresponding to the signal intensity determined by the first method and the second method after adjusting an ion transmission ratio of the ion lens by changing the voltage applied to the ion lens so that the signal intensity of each of all the mass numbers is within the calibration range at least one time for a mass number having the signal intensity above the calibration range, which is determined for the density calibration with respect to the mass number corresponding to each element in the standard density sample introduced to the inductively coupled plasma mass spectroscopy apparatus for the density calibration,
whereby a sample other than the standard density sample is not necessary as a sample for determining the conversion coefficient of the mass number.
